(19) United States
(12) Patent Application Publication
(10) Pub. No.: US 2010/0246416 A1
(43) Pub. Date: Sep. 30, 2010

(54) SYSTEMS AND METHODS FOR REMOTE TESTING OF WIRELESS LAN ACCESS POINTS

(76) Inventors: Amit SINHA, Marlborough, MA (US); Tom Gulick, Groton, MA (US); Adam Mayer, Cumming, GA (US); Matt Winter, Tucker, GA (US)

Correspondence Address: Clements Bernard PLLC, 1901 Roxborough Road, Suite 250, Charlotte, NC, 28211, US

(21) Appl. No.: 12/410,967

(22) Filed: Mar. 25, 2009

(51) Int. Cl. H04L 12/26; H04W 84/02

(52) U.S. Cl. 370/250; 370/338

(57) ABSTRACT

The present disclosure describes systems and methods for remote testing and troubleshooting of a Wireless Local Area Network (WLAN) using one or more distributed WLAN sensors and one or more servers. Specifically, the invention describes a method to test WLAN access points (APs) for connectivity and performance in the field. In an exemplary embodiment, the one or more distributed WLAN sensors and one or more servers can include a wireless monitoring system, such as a wireless intrusion prevention or detection system. The present invention utilizes a distributed network of WLAN sensors that typically operate to monitor the WLAN, and as needed, the present invention converts the monitoring sensors to WLAN clients capable to connecting and remotely testing one or more WLAN APs.

### FIELD OF THE INVENTION

The present invention relates generally to wireless networking. More particularly, the present invention provides systems and methods for remote troubleshooting of a Wireless Local Area Networks (WLAN) using one or more distributed WLAN sensors and one or more servers

### BACKGROUND OF THE INVENTION

Wireless networking technology is growing in popularity. Businesses are not only migrating to wireless networking, they are steadily integrating wireless technology and associated components into their wired infrastructure. The demand for Wireless Local Area Networks (WLANs) is fueled by the growth of mobile computing devices, such as laptops and personal digital assistants (PDAs), and a desire by users for continual connections to the network without having to “plug in.”

Managing distributed WLANs poses unique challenges. The operational expenses in managing a large WLAN can be significant because wireless network outages are a common and frequent occurrence. Unlike wired networks, WLANs operate in a shared wireless medium that is constantly changing. In addition, wireless devices are mobile and frequently roam between different WLANs. WLAN performance and coverage can also be significantly impacted by noise and transient interference in the local air space. Similarly, misconfigurations, such as improper security keys, can prevent a device from successfully communicating.

The cost of testing and troubleshooting a wireless network is significant. Typically, when a WLAN goes down or a user reports connectivity problems, an on-site technician armed with a wireless laptop-based network analyzer is sent on site to capture wireless traffic and analyze the root cause of the issue. These techniques are costly and time consuming. Thus, the ability to “look into” a wireless network remotely from a central facility, perform connection tests, and analyze data would be indispensable for efficient WLAN troubleshooting.

### BRIEF SUMMARY OF THE INVENTION

In various exemplary embodiments, the present invention describes systems and methods for remote testing and troubleshooting of a WLAN using one or more distributed WLAN sensors and one or more servers. Specifically, the invention describes a method to test WLAN access points (APs) for connectivity and performance in the field. In an exemplary embodiment, the one or more distributed WLAN sensors and one or more servers can include a wireless monitoring system, such as a wireless intrusion prevention or detection system. The present invention utilizes a distributed network of WLAN sensors that typically operate to monitor the WLAN, and as needed, the present invention converts the monitoring sensors to WLAN clients capable to connecting and remotely testing one or more WLAN APs.

In an exemplary embodiment of the present invention, a method for remote testing of a wireless local area network access point includes selecting an access point to test; selecting a sensor in range of the access point; configuring the sensor as a wireless local area network client; and testing the access point with the sensor. The sensor includes a monitoring sensor configured to provide wireless network monitoring for wireless network intrusions in conjunction with a server that is in communication with the sensor. Configuring the sensor as a wireless local area network client includes assigning the sensor a media access control address to operate as a wireless client device, and can further include configuring the sensor to lock on and operate on a wireless channel that the access point is operating on. Testing the access point includes performing layer two connectivity tests and layer three connectivity tests. The layer two connectivity tests can include any of performing an association between the sensor and the AP, performing a four-way handshake and installing temporal and group keys, and performing physical layer rate testing including measuring a packet error rate based on acknowledgments received at the sensor from the AP. The layer three connectivity tests can include any of assigning an Internet Protocol address to the sensor operating as a wireless client, performing a ping to a known machine on a wired network connected to the wireless network, performing a traceroute test to the known machine, performing network performance testing including performing Transmission Control Protocol (TCP) and User Datagram Protocol (UDP) throughput tests, scanning for open/blocked ports and services, and performing a Domain Name System test. The layer two connectivity tests and the layer three connectivity tests are each selected based upon user requirements and network configuration.

In another exemplary embodiment of the present invention, a wireless monitoring system configured for remote testing of an access point includes one or more wireless sensors configured to monitor traffic on a wireless network; one or more servers communicatively coupled to the one or more wireless sensors; and a remote access point testing procedure executed on one of the one or more wireless sensors and one of the one or more servers, wherein the remote access point testing procedure is configured to convert the one of the one or more wireless sensors to a wireless client in order to remotely test the access point. The one or more wireless sensors and the one or more servers include one of a wireless monitoring system, a wireless intrusion detection system, and a wireless intrusion prevention system. The one or more wireless sensors are configured to operate in a promiscuous mode while monitoring and converted to client mode to remotely test the access point. Converting the one of the one or more wireless sensors to a wireless client includes assigning the one of the one or more wireless sensors a media access control address to operate as a wireless client device. To remotely test the access point, the system performs layer two connectivity tests and layer three connectivity tests. The layer two connectivity tests can include any of performing an association between the sensor and the AP, performing a four-way handshake and installing temporal and group keys, and performing physical layer rate testing including measuring a packet error rate based on acknowledgments received at the sensor from the AP. The layer three connectivity tests can include any of assigning an Internet Protocol address to the sensor operating as a wireless client, performing a ping to a known machine on a wired network connected to the wireless network, performing a traceroute test to the known machine, performing network performance testing including performing Transmission Control Protocol (TCP) and User Datagram Protocol (UDP) throughput tests, scanning for open/blocked ports and services, and performing a Domain Name System test. The wireless monitoring system can further include a graphical user interface for configuring, executing the test of the access point, and providing a test report.

In yet another exemplary embodiment of the present invention, a wireless monitoring method includes providing the wireless monitoring system including a server communicatively coupled to one or more distributed wireless sensors; monitoring the wireless network for intrusions with the wireless monitoring system; configuring access point test parameters in the wireless monitoring system; and responsive to access point test parameters, testing one or more access points in the wireless network with the wireless monitoring system. The testing includes converting a sensor of the one or more distributed wireless sensors into a wireless client configured to communicate on the wireless network and performing wireless connectivity tests between the sensor and the access point. The layer two connectivity tests can include performing an association between the sensor and the AP, performing a four-way handshake and installing temporal and group keys, and performing physical layer rate testing including measuring a packet error rate based on acknowledgments received at the sensor from the AP. The layer three connectivity tests can include assigning an Internet Protocol address to the sensor operating as a wireless client, performing a ping to a known machine on a wired network connected to the wireless network, performing a traceroute test to the known machine, performing network performance testing including performing Transmission Control Protocol (TCP) and User Datagram Protocol (UDP) throughput tests, scanning for open/blocked ports and services, and performing a Domain Name System test.

### BRIEF DESCRIPTION OF THE DRAWINGS

The present invention is illustrated and described herein with reference to the various drawings, in which like reference numbers denote like method steps and/or system components, respectively, and in which:

FIG. 1 is a network including both wired and wireless components according to an exemplary embodiment of the present invention;

FIG. 2 is a wireless detection system configured for remote testing and troubleshooting of the wireless networks according to an exemplary embodiment of the present invention;

FIG. 3 is a flowchart of an access point (AP) testing procedure according to an exemplary embodiment of the present invention;

FIG. 4 is a flowchart of a layer two connectivity test for APs according to an exemplary embodiment of the present invention;

FIG. 5 is a flowchart of a layer three connectivity test for APs according to an exemplary embodiment of the present invention;

FIG. 6 is a block diagram of wireless sensors according to an exemplary embodiment of the present invention;

FIG. 7 is a block diagram of a server configured to perform remote AP testing in conjunction with one or more sensors according to an exemplary embodiment of the present invention; and

FIGS. 8-15 are diagrams of an exemplary operation of the AP testing procedure illustrated through various graphical user interfaces (GUIs) according to an exemplary embodiment of the present invention.

### DETAILED DESCRIPTION OF THE INVENTION

In various exemplary embodiments, the present invention describes systems and methods for remote testing and troubleshooting of a WLAN using one or more distributed WLAN sensors and one or more servers. Specifically, the invention describes a method to test WLAN access points (APs) for connectivity and performance in the field. In an exemplary embodiment, the one or more distributed WLAN sensors and one or more servers can include a wireless monitoring system, such as a wireless intrusion prevention or detection system. The present invention utilizes a distributed network of WLAN sensors that typically operate to monitor the WLAN, and as needed, the present invention converts the monitoring sensors to WLAN clients capable to connecting and remotely testing one or more WLAN APs.

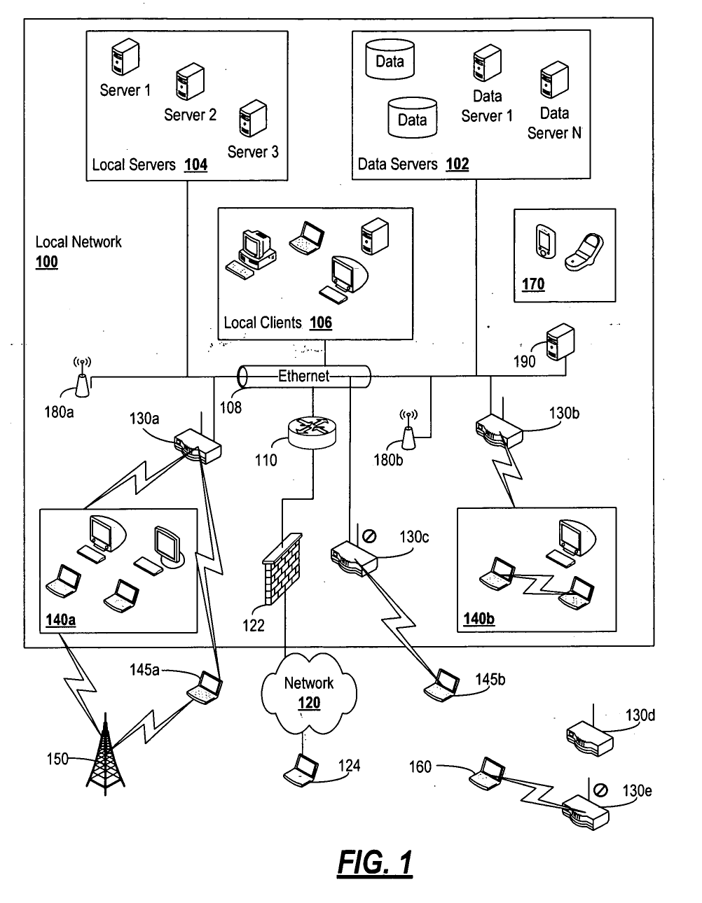

Referring to FIG. 1, a network 100 including both wired and wireless components is illustrated according to an exemplary embodiment of the present invention. The wired components depicted in FIG. 1 include a variety of connected systems such as network accessible data storage servers 102, local servers 104, and local clients 106. The data storage servers 102, local servers 104, and local clients 106 are connected through an Ethernet 108 connection. A router 110 connects the Ethernet 108 and the components 102, 104, 106 to an external network 120, such as the Internet. A firewall 122 can be included to protect the wired local network and act as a security gate to prevent unauthorized traffic coming from the network 120 such as a potential hacker 124. The firewall 122 can effectively deter an attack from a wired hacker via the network 120.

By installing wireless access points (AP) 130a, 130b to the wired network (e.g., Ethernet 108 and router 110), personal computers and laptops equipped with wireless local area network (WLAN) cards and other wireless-enabled devices create a wireless network 140a, 140b which can connect to the wired network at broadband speeds (i.e., 11 Mb/s up to 600 Mb/s) using IEEE 802.11a/b/g/n protocols for example.

Wireless networks 140a, 140b operate over the airspace which is an uncontrolled and shared medium lacking the equivalent physical control and accessibility of its wired counterpart. As such, wireless hackers 145a, 145b can enter the local network 100 through the access points 130a, 130b even if the access points 130a, 130b are located behind the firewall 122. Therefore, wireless networks 140a, 140b (in conjunction with access points 130a, 130b) can provide opportunities for unauthorized users to attack the network 100, which can include in various examples: a local area network, a wide area network, a metropolitan area network, a corporate intranet, among many others.

A wireless AP 130c can be installed unbeknownst to an enterprise (e.g., rogue AP) or it can be installed and misconfigured (e.g. misconfigured AP). As such, the AP 130c can also provide opportunities for unauthorized users to access the network 100. Due to the low cost of APs 130c, anyone with access to an enterprise can install a rogue AP 130c and connect it to the Ethernet 108 network providing complete wireless access to the enterprise. A misconfigured AP 130c can have the wrong encryption settings allowing any user to gain access to the enterprise.

Also, municipal wireless networks 150 are proliferating such as local governments providing free or reduced cost IEEE 802.11 access. These networks 150 can be used by the wireless hacker 145a to gain access to a device on the enterprise's wireless network 140a which is set to allow inbound connections effectively bypassing the enterprise firewall and content filtering. Additionally, mobile users 160 face threats from evil twin APs 130e which gain access to the user's 160 login credentials by posing as a legitimate AP 130d. Such a threat can allow the evil twin AP 130e to relay the credentials to a hacker for access to the enterprise's wireless network 140a, 140b.

In addition to IEEE 802.11 access, other wireless protocols 170 such as Bluetooth, WiMax, and cellular data are emerging and proliferating. Bluetooth is deployed within the enterprise with PDA, cellular phones, and the like. WiMax is a wireless standard for the delivery of last mile wireless broadband access as an alternative to cable and DSL.

The network 100 can be configured with wireless sensors 180a, 180b and a server 190 for monitoring, detecting, and preventing wireless intrusions on the wireless networks 140a, 140b. The sensors 180a, 180b connect to the Ethernet 108 network, and each sensor 180a, 180b is located to monitor, detect, and prevent intrusions over a pre-defined area for wireless activity. The sensors 180a, 180b are configured to monitor data transmitted on the wireless networks 140a, 140b and to communicate relevant data, events, and statistics to the server 190. The sensors 180a, 180b can be configured to monitor one or more wireless channels such as IEEE 802.11 standard channels and non-standard user-defined channels. The sensors 180a, 180b can monitor more than one channel simultaneously if the sensors 180a, 180b are configured with multiple wireless radios. The sensors 180a, 180b can include a local processor to perform data analysis on wireless events to minimize communications to the server 190.

The server 190 connects to the Ethernet 108 or optionally through the network 120 (not shown) and the server 190 is configured to receive and correlate data, events, and statistics from the sensors 180a, 180b. Further, multiple servers 190 can operate to provide redundancy and load-balancing. Additionally in some examples, access points 130 and/or local clients 106 can occasionally operate as sensors 180a, 180b to communicate data, events, and statistics to the server 190. Also, local clients 106 equipped with WLAN cards can be configured with software agents, allowing the local clients 106 to periodically monitor the wireless networks 140a, 140b and to communicate data, events, and statistics from monitoring the wireless networks 140a, 140b to the server 190.

The server 190 can be configured to detect attacks and events, network performance degradation, and network policy compliance on the wireless networks 140a, 140b. Further, the server 190 can be configured to direct the sensors 180a, 180b to terminate a rogue wireless client (e.g. an unauthorized user) such as wireless hackers 145a, 145b. Also, the server 190 can include a data store to log history and trends relating to monitoring of the wireless network 140a, 140b. The combination of the server 190 and sensors 180a, 180b is known as a wireless intrusion prevention system (WIPS) or a wireless intrusion detection system (WIDS).

This present invention provides systems and methods for remote testing and troubleshooting of the wireless networks 140a, 140b using the sensors 180a, 180b and the server 190. Specifically, the sensors 180a, 180b and the server 190 can be configured to test WLAN access points 130 for connectivity and performance in the field. Additionally, the server 190 can direct the sensors 180a, 180b to act as WLAN clients capable to connecting and testing the one or more access points 130.

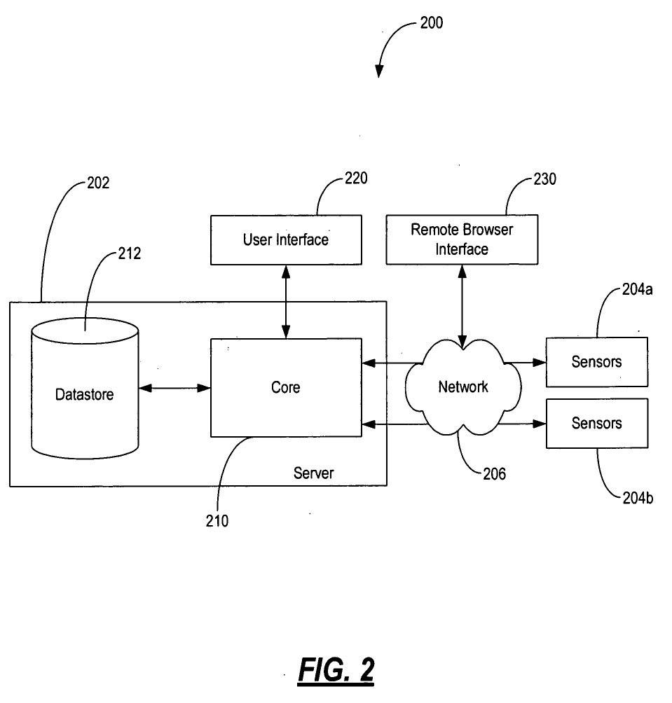

Referring to FIG. 2, a wireless detection system 200 configured for remote testing and troubleshooting of the wireless networks is illustrated according to an exemplary embodiment of the present invention. The wireless detection system 200 includes a server 202 connected through one or more sensors 204a, 204b through a network 206. The network 206 can include wired and wireless components and can be geographically diverse. The sensors 204a, 204b are positioned at locations to monitor wireless traffic over the network 206. The sensors 204a, 204b are accordingly proximate to multiples APs, wireless clients, and the like.

The server 202 includes a core 210 and a data store 212. The core 210 generally includes a processing element and interfaces to the network 206. The core 210 is configured to receive data from the sensors 204a, 204b, to analyze the data, and to store the data in the data store 212. In an exemplary embodiment, the core 210 can apply multiple intrusion detection tests to received data to detect possible intrusions or violations. These intrusion detection tests can relate to wireless policy deviation, statistical anomalies, signature-based attacks, wireless protocol usage, and the like.

The server 202 can be accessed through a user interface 220 locally or remotely through a remote browser interface 230. Specifically, the server 202 can include a Graphical User Interface (GUI) to display network topology, alarms and warnings, network performance, and the like. The GUI can also be utilized to configure the server 202 and the sensors 204a, 204b.

The present invention utilizes the distributed nature of the sensors 204a, 204b and the proximity of the sensors 204a, 204b to APs to enable remote testing and troubleshooting of APs. The sensors 204a, 204b typically operate in a monitoring mode thereby receiving and processing wireless traffic. Occasionally, the sensors 204a, 204b can transmit for various active defense mechanisms to terminate a rogue device. The present invention utilizes the sensors 204a, 204b as WLAN client devices for purposes of testing and troubleshooting APs remotely.

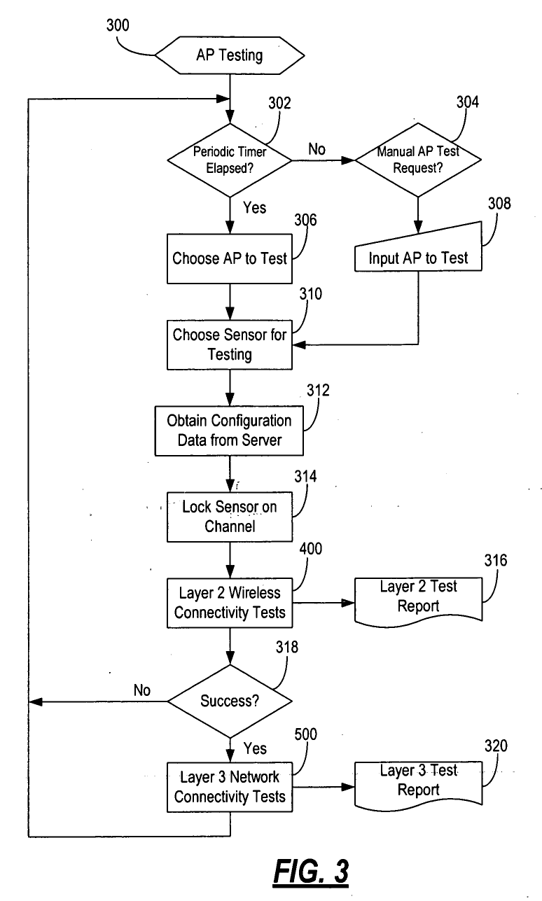

Referring to FIG. 3, a flowchart illustrates an AP testing procedure 300 according to an exemplary embodiment of the present invention. The AP testing procedure 300 can start when a periodic timer elapses (step 302) or based on a manual AP test request (step 304). For example, the periodic timer can be set for periodic testing of one or more WLAN APs, and the periodic timer can be set through a server, e.g. server 202. Alternatively, the AP testing procedure 300 can be initiated manually from any remote location with network access, such as through the server.

The AP testing procedure 300 selects a WLAN AP to test (step 306) for a periodic test or receives an input for which WLAN AP to test (step 308) for a manual test. For example, the server can periodically test one or more APs based on a predetermined order or schedule, based on the server's determination in regard to a particular AP (e.g., performance degradation), and the like. For the manual test, the server can prompt a user to select an AP, such as through a list.

One the AP is chosen for testing, a sensor is chosen to test the AP (step 310). The sensor can be chosen by the server based on proximity or the like. For example, the sensor that is closest to the AP with the best received signal strength can be selected or can be a default choice for selection. Other sensors in range can also be used.

Next, the AP testing procedure 300 obtains configuration data regarding the AP from the server or from user input (step 312). The configuration data can include security keys, service set identifier (SSID), Internet Protocol (IP) address, AP password, and the like. This data can be stored on the server, such as in a pre-configured profile, or input from the user. The server can include a user-modifiable profile for each AP.

The selected sensor is then locked on the AP's operating channel (step 314). For example, WLAN APs operating according to the various IEEE 802.11 specifications can use different channels in the 2.4 GHz and 5 GHz bands. For example, the sensor can typically operate in promiscuous mode while it is solely monitoring the WLAN (e.g., to avoid detection by a rogue device). In an AP testing mode, the sensor acts as a client and also transmits.

Once the sensor is locked on the appropriate channel and configured, the sensor is utilized to perform various layer two (step 400) and layer three (step 500) connectivity tests. For example, the layer two 400 tests can include various IEEE 802.11 connectivity tests, such as Authentication, Association, and Wi-Fi Protected Access (WPA) Handshake. The layer three 500 tests can include Dynamic Host Configuration Protocol (DHCP), Address Resolution Protocol (ARP), Traceroute, Domain Name System (DNS), Ping, and Portscan related tests.

Accordingly, the sensor operates as a wireless client to perform these tests, and not in a promiscuous receive-only mode as a sensor. Additionally, the AP testing procedure 300 can produce a layer two test report (step 316), and exit if the layer two test is unsuccessful (step 318). Also, the AP testing procedure 300 can produce a layer three test report (step 320), and perform the AP testing procedure 300 again for a different AP.

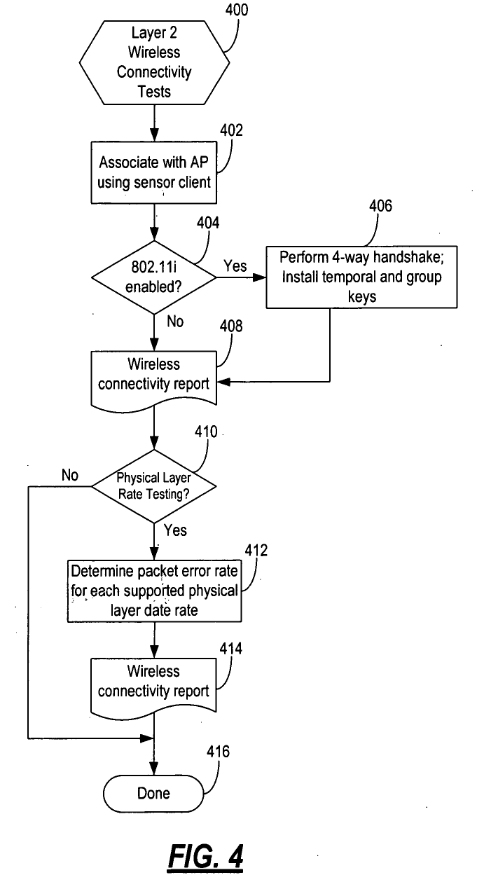

Referring to FIG. 4, a flowchart illustrates a layer two connectivity test 400 for WLAN APs according to an exemplary embodiment of the present invention. First, the sensor associates with the AP as if the sensor was a valid client (step 402). This includes sending an association request, and waiting until a valid association response is received from the AP. This is done through an exchange of IEEE 802.11 management frames between the sensor and the AP including an association request frame and an association response frame.

The association request frame is sent from the sensor to enable the AP to allocate resources and synchronize to the sensor (acting as a client). The frame carries information about the sensor including supported data rates and the SSID of the network the sensor wishes to associate with. If the request is accepted, the AP reserves memory and establishes an association ID for the sensor. The association response frame is sent from the AP to the sensor with an acceptance or rejection to the association request. If it is an acceptance, the frame contains information such an association ID and supported data rates.

If the AP uses 802.11i-based security (step 404), a four-way handshake is performed and temporal as well as group keys are installed (step 406). Based on the success of the layer two connection an appropriate report is generated (step 408). Further, if physical layer rate testing is enabled (step 410), the sensor sends several data packets at the supported physical layer rates (based on the association) and measures the packet error rate (PER) based on acknowledgements received from the AP (step 412).

The PER can use any technique for conducting error tests on an 802.11 device. For example, the system can obtain raw data bits received by the sensor and compare them with sent ones from the AP to determine bit error rate (BER). Also, the sensor can read out an internal cyclic redundancy check (CRC) mismatch counter. With the 32-bit CRC used by the 802.11 standard, the probability of undetected erroneous packets is very small. Therefore the CRC mismatch method is commonly used, as the practical implementation costs are low.

Once the PER is complete, the layer two connectivity test 400 can provide a wireless connectivity report (step 414). Upon completion (step 416), the layer two connectivity test 400 returns to the AP testing procedure 300 in FIG. 3.

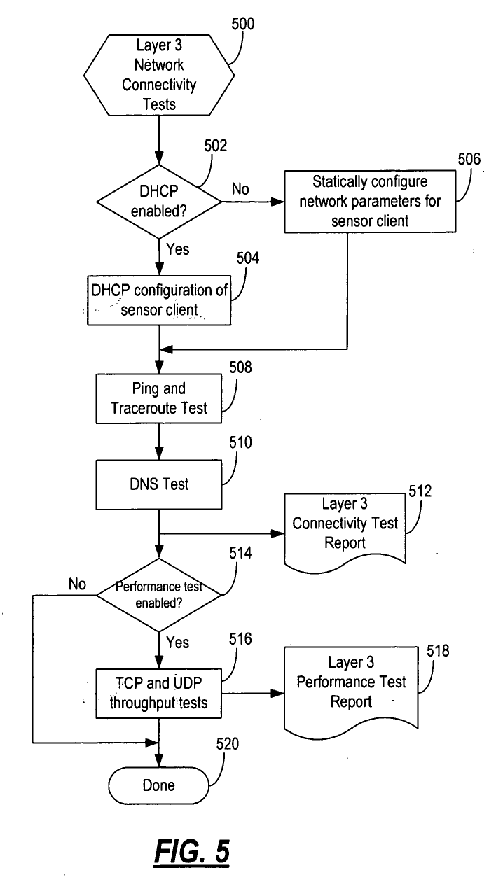

Referring to FIG. 5, a flowchart illustrates a layer three connectivity test 500 for WLAN APs according to an exemplary embodiment of the present invention. As described in the AP testing procedure 300 in FIG. 3, the layer three connectivity test 500 is performed after a successful layer two connection and test between the sensor and the AP. If the sensor is configured for DHCP (step 502), the sensor automatically obtains an IP address from the AP through DHCP (step 504). Otherwise, the network parameters are statically configured for the sensor based on settings specified by the user through a user interface (UI) or settings stored in a profile (step 506).

Once an IP address is obtained, the sensor performs a ping and traceroute test to see if a client can successfully ping a known machine on the wired network (step 508). The ping performs a test to see whether the sensor can reach a particular host through the AP over an IP network, and traceroute is a tool used to determine the route taken by packets across an IP network. These tests can be performed to an arbitrary device to determine if a wireless client can reach a wired device via the AP.

Next, the layer three connectivity test 500 performs a DNS test (step 510). This test can determine if the sensor can communicate using DNS to another device over the IP network. After completion of these tests, the layer three connectivity test 500 can provide a layer three connectivity test report (step 512). Additionally, the layer three connectivity test 500 can include other types of layer three tests as are known in the art such as test for open or blocked ports.

The layer three connectivity test 500 can include network performance testing (step 514). If network performance testing is enabled, the sensor generates a traffic load to test the throughput obtained from the wireless network performing Transmission Control Protocol (TCP) and User Datagram Protocol (UDP) throughput tests (step 516). The layer three connectivity test 500 can provide a layer three performance test report (step 518), and return to the AP testing procedure 300 in FIG. 3 (step 520).

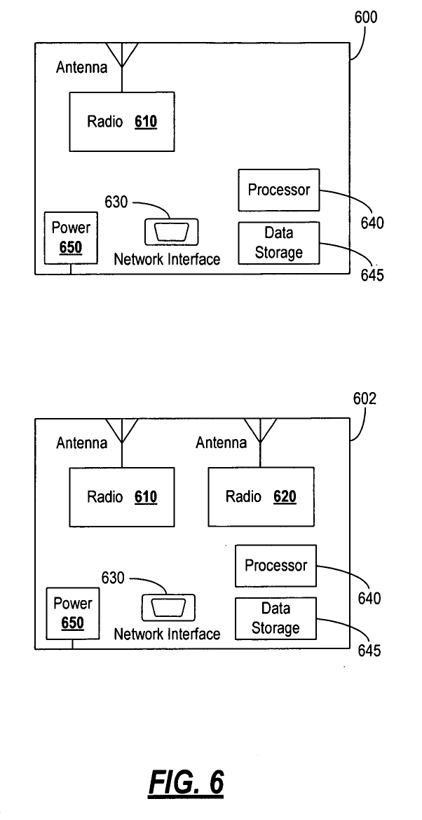

Referring to FIG. 6, wireless sensors 600, 602 are illustrated according to an exemplary embodiment of the present invention. The wireless sensors 600, 602 provide monitoring of multiple channels on a wireless network for wireless activity; the ability to transmit and receive frames on the wireless network; and the ability to communicate data, events, and statistics to a server. The wireless sensor 600 is configured with a single radio 610, and the wireless sensor 602 is configured with dual radios 610, 620. Additionally, wireless sensors can include more than two radios to provide the ability to monitor and transmit over more than two channels simultaneously.

The antennas on the radios 610, 620 are configured to receive and transmit wireless signals according to a predetermined protocol such as one of the IEEE 802.11 protocols. The radios 610, 620 can be configured as transceivers or as receiving devices. When configured as transceivers, the radios 610, 620 operate to transmit and receive wireless traffic similar to a wireless AP or a wireless client, and other wireless devices can connect to the radios 610, 620 and communicate through a network interface 630. When configured as a receiving device, the radios 610, 620 monitor the wireless network only.

In an exemplary embodiment, the wireless radio 602 includes one transceiver radio and one sensing radio to allow monitoring of the wireless network with the sensing radio and active transmission with the transceiver radio. The radios 610, 620 can be operated as transceivers in “promiscuous mode” in order to be undetectable from the airwaves and still read all IEEE 802.11 network traffic. The sensor software embedded on the device would capture IEEE 802.11 frames from the wireless network, analyze management, control and data frames, collect events and statistics and send it to a server. The sensor 600, 602 can further include a local processor 640 that serves as the system processor. Optionally, the local processor 640 can be configured to perform data processing on collected data prior to sending it to the server to minimize network communications by performing distributed data analysis.

The network interface 630 is configured to connect to an external network such as a local Ethernet or a direct connection such as an RS232. The network interface 630 is utilized to communicate to external devices such as the server. The sensor 600, 602 can further include local data storage 645 that serves as a system data store (SDS). This local storage 645 contains any necessary operating code and/or data such as accumulated security data, network configuration data, sensor identification information and/or network communication related data. The local storage 645 typically includes DRAM, FLASH memory or combinations thereof.

The local processor 640 supports communication management, security collection, and security analysis functionality. The local processor 640 can be any microprocessor, ASIC, FPGA or combination thereof that has the computing power capable of managing the radios 610, 620 and the auxiliary components of the device (e.g., local storage 645, network interface 620, etc.). The sensors 600, 602 also include a connection to a power source 650 such as an alternating current (AC) interface, direct current (DC) interface, power over Ethernet (PoE) compatible interface, or a repository for one or more disposable and/or rechargeable batteries.

As described herein, the sensors 600, 602 can be uses to collect and forward security related data, events, and statistics to the server 201 for further processing and analysis. In some particular embodiments using an IEEE 802.11 network, the sensors 600, 602 read IEEE 802.11 management and control frames, aggregate statistics and send collected data to a server. A wireless sensor can have several embodiments including the sensors 600, 602 depicted in FIG. 6. Further, a wireless sensor could include a modified IEEE 802.11 access point configured forward management and control frames and to communicate the data back to a server for analysis.

Additionally, APs and wireless clients can provide a similar functionality to wireless sensors. APs can be configured to monitor the wireless network while idle and to report data, statistics, and events back to the server. Wireless clients with WLAN cards can be configured with a software agent that utilizes the idle time on the client to monitor the wireless network and to report data, statistics, and events back to the server.

A wireless sensor will typically include at least one IEEE 802.11 radio capable of reading IEEE 802.11 frames. To provide functionality for securing a wireless network, the wireless sensor analyzes IEEE 802.11 management, control and data frames, and sends real-time or batched data back to a centralized server for analysis and processing to determine intrusions or other network activity such as health or performance monitoring or performing such analysis and processing locally in peer-to-peer configurations.

The present invention extends the functionality of the sensors 600, 602 from being passive monitoring devices and/or active defense devices to also operate as testing and troubleshooting devices. Specifically, the sensors 600, 602 can be used as wireless clients managed by a centralized server for the purposes of remotely testing connectivity at layers two and three with an AP or group of APs. Here, the sensors 600, 602 are configured as wireless clients seeking to associate with an AP. Once associated, the sensors 600, 602 can perform the connectivity tests described herein under the direction of the centralized server, and report results to the centralized server.

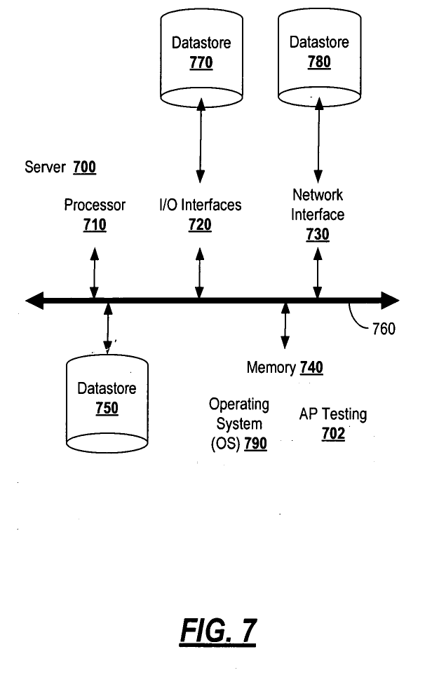

Referring to FIG. 7, a block diagram illustrates a server 700 configured to perform remote AP testing 702 in conjunction with one or more WLAN sensors according to an exemplary embodiment of the present invention. The server 700 can be a digital computer that, in terms of hardware architecture, generally includes a processor 710, input/output (I/O) interfaces 720, a network interface 730, memory 740, and data store 750. The components (710, 720, 730, 740, and 750) are communicatively coupled via a local interface 760. The local interface 760 can be, for example but not limited to, one or more buses or other wired or wireless connections, as is known in the art. The local interface 760 can have additional elements, which are omitted for simplicity, such as controllers, buffers (caches), drivers, repeaters, and receivers, among many others, to enable communications. Further, the local interface 760 can include address, control, and/or data connections to enable appropriate communications among the aforementioned components.

The processor 710 is a hardware device for executing software instructions. The processor 710 can be any custom made or commercially available processor, a central processing unit (CPU), an auxiliary processor among several processors associated with the server 700, a semiconductor-based microprocessor (in the form of a microchip or chip set), or generally any device for executing software instructions. When the server 700 is in operation, the processor 710 is configured to execute software stored within the memory 740, to communicate data to and from the memory 740, and to generally control operations of the server 700 pursuant to the software instructions.

The I/O interfaces 720 can be used to receive user input from and/or for providing system output to one or more devices or components. User input can be provided via, for example, a keyboard and/or a mouse. System output can be provided via a display device and a printer (not shown). I/O interfaces 720 can include, for example, a serial port, a parallel port, a small computer system interface (SCSI), an infrared (IR) interface, a radio frequency (RF) interface, and/or a universal serial bus (USB) interface.

The network interface 730 can be used to enable the server 700 to communicate on a network. The network interfaces 730 can include, for example, an Ethernet card (e.g., 10BaseT, Fast Ethernet, Gigabit Ethernet) or a WLAN card (e.g., 802.11a/b/g/n). The network interfaces 730 can include address, control, and/or data connections to enable appropriate communications on the network. For example, the network interface 730 can be utilized to communicate with one or more WLAN sensor, such as the sensors 600, 602 in FIG. 6. The sensors 600, 602 can communicate processed WLAN data relating to APs, wireless clients, and the like within range to the sensors 600, 602 to the server 700 through the network interface 730. The server 700 can direct the sensors 600, 602 to perform remote AP testing through the network interface 730.

The data store 750 can be used to store alarms, events, data, state, AP profiles, and statistics that the server 750 receives or analyzes from devices monitoring a wireless network. The data store can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the data store may incorporate electronic, magnetic, optical, and/or other types of storage media.

In one example, the data store 750 can be located internal to the server 700 such as, for example, an internal hard drive connected to the local interface 760 in the server 700. Additionally in another embodiment, a data store 770 can be located external to the server 700 such as, for example, an external hard drive connected to the I/O interfaces 720 (e.g., SCSI or USB connection). Finally in a third embodiment, a data store 780 can be connected to the server 700 through a network, such as, for example, a network attached file server.

The memory 740 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 740 may incorporate electronic, magnetic, optical, and/or other types of storage media. Note that the memory 740 can have a distributed architecture, where various components are situated remotely from one another, but can be accessed by the processor 710.

The software in memory 740 can include one or more software programs, each of which includes an ordered listing of executable instructions for implementing logical functions. In the example of FIG. 7, the software in the memory system 740 includes the AP testing 702 program and a suitable operating system (O/S) 790. The operating system 790 essentially controls the execution of other computer programs, such as the AP testing 702 program, and provides scheduling, input-output control, file and data management, memory management, and communication control and related services. The operating system 790 can be any of Windows NT, Windows 2000, Windows XP, Windows Vista (all available from Microsoft, Corp. of Redmond, Wash.), Solaris (available from Sun Microsystems, Inc. of Palo Alto, Calif.), or LINUX (or another UNIX variant) (such as available from RedHat of Raleigh, N.C.).

The AP testing 702 program is a software program loaded in the memory 740 of the server 700 configured to interface with one or more remote WLAN sensors (e.g., sensors 600, 602 in FIG. 6) for remotely testing and troubleshooting WLAN APs at layer two and three based on the techniques described herein. For example, the AP testing program 702 can be configured to execute the flowcharts described in FIGS. 3-5, i.e. the AP testing procedure 300. Additionally, the AP testing 702 program can be configured to provide a user a GUI to facilitate the configuration of the remote AP testing and troubleshooting.

In another exemplary embodiment, the server 700 can include configuration settings in the data store 750 for various APs. The AP testing 702 program can be configured to automatically adjust these configuration settings responsive to results from remote testing and troubleshooting.

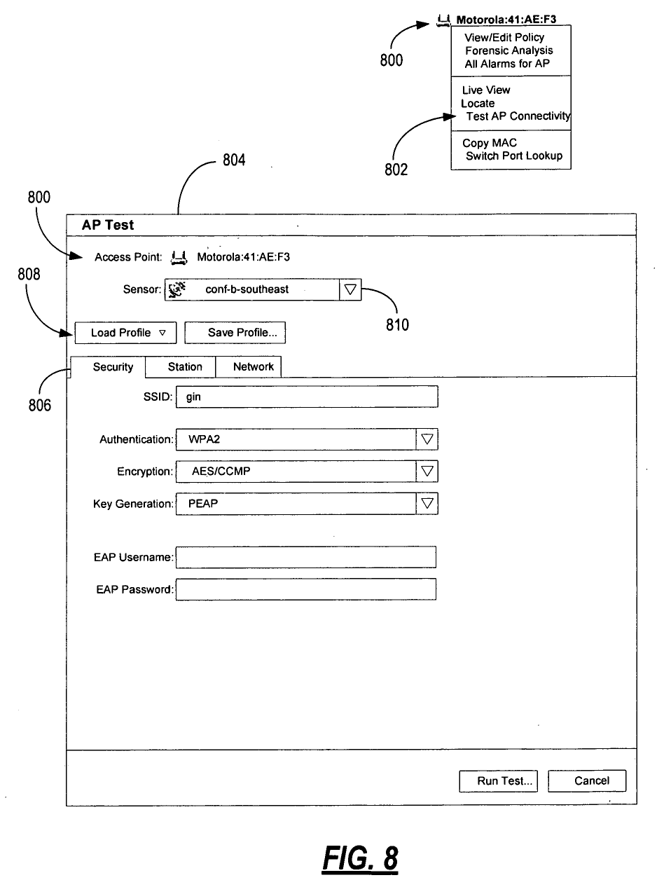

Referring to FIGS. 8-15, an exemplary operation of the AP testing procedure 300 is illustrated through various graphical user interfaces (GUIs) according to an exemplary embodiment of the present invention. As described herein, the AP testing procedure 300 can be executed on a centralized server (e.g., server 190, 202, 700 from FIGS. 1, 2, and 7) and remote WLAN sensors (e.g., sensors 180, 204, 600, 602 from FIGS. 1, 2, and 6). The exemplary operation illustrates various steps and exemplary GUI screens for the AP testing procedure 300.

Generally, the server 700 can display a map or list of various WLAN APs. In an exemplary embodiment, a user can click on a specific AP, such as AP 800, and select Test AP Connectivity 802. An AP test screen 804 allows the user to input various settings associated for remote testing of the AP 800. FIG. 8 illustrates a security tab 806 in the AP test screen 804. Herein, the user can input various parameters, such as SSID, authentication type (Open, Wired Equivalent Privacy (WEP), WPA, WPA2), encryption type (WEP, Temporal Key Integrity Protocol (TKIP), Advanced Encryption Standard (AES)), Extensible Authentication Protocol (EAP) user name and EAP type, etc. Alternatively, a profile 808 can be loaded or saved for the AP 800. Also, a sensor 810 can be selected for performing the test, and the sensor 810 can automatically default to a closest sensor and the user can manually select an alternative sensor through a pull-down menu or the like.

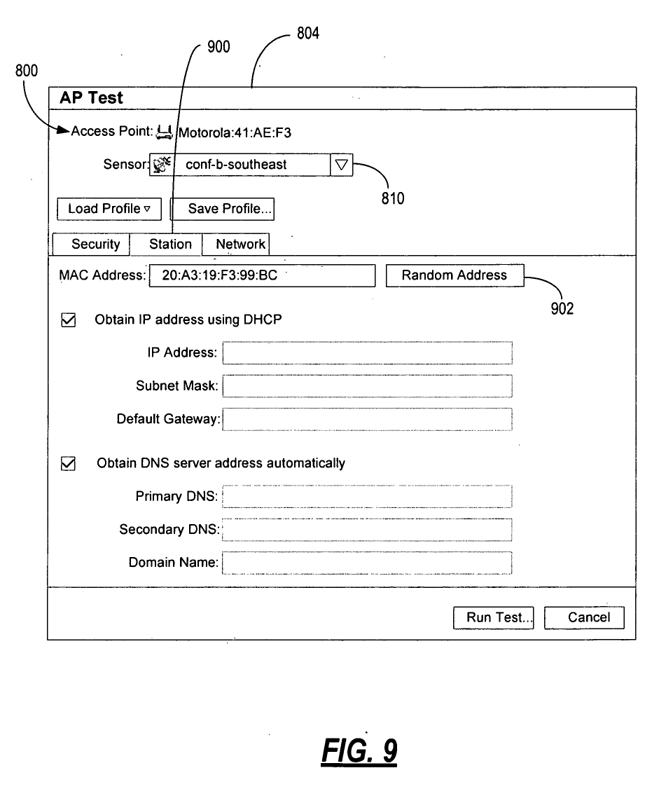

FIG. 9 illustrates the AP test screen 804 showing a station tab 900 for configuring the sensor 810. The station tab 900 allows the user to configure the WLAN sensor 810 as a WLAN client on the WLAN network in order to perform the remote AP testing. Specifically, various parameters can be configured including the sensor's MAC address, DHCP settings, IP address/gateway/netmask, DNS servers, etc. and stored as profiles to use later. Note, a random address 902 can be selected for the MAC address of the sensor client.

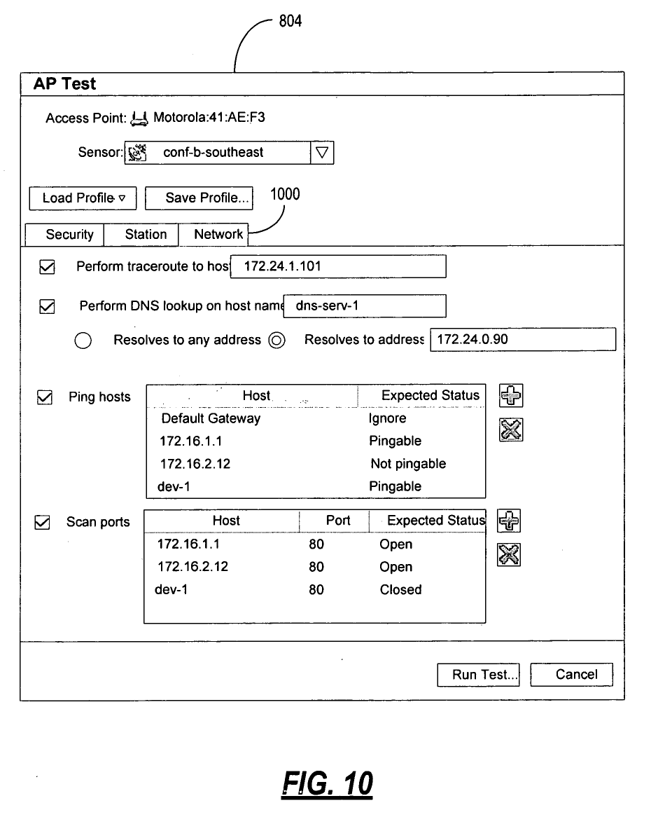

FIG. 10 illustrates the AP test screen 804 showing a network tab 1000 for configuring various network related parameters for the remote AP test. Here, the user can configure various servers to ping and traceroute. Also the scan and throughput test can also be configured through the network tab 1000.

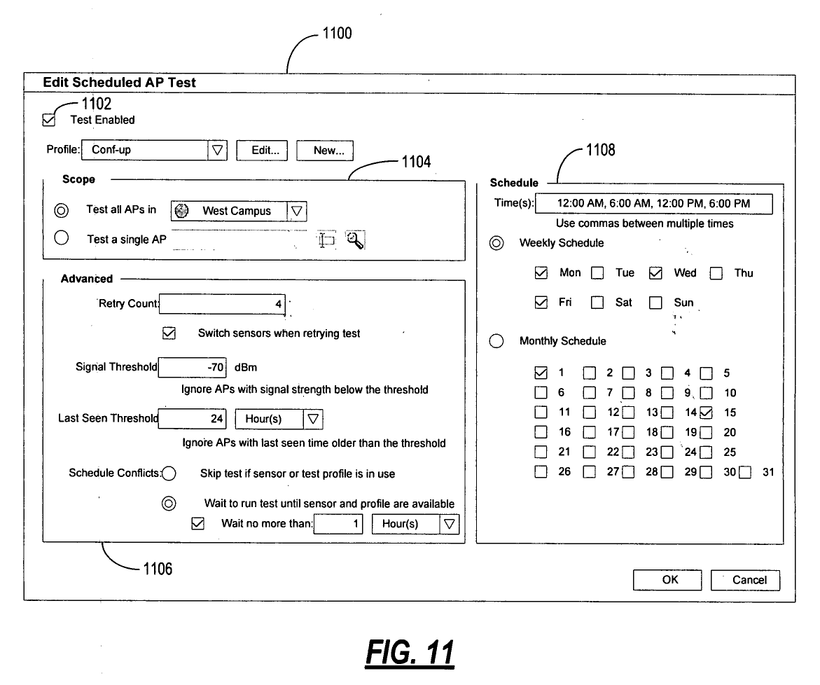

FIG. 11 illustrates a GUI screen 1100 for scheduling automatic periodic testing of an AP or a group of APs. Here, testing can be enabled through a check box 1102. The user can define a scope 1104 of the testing, e.g. testing a single AP or a group of APs. Various testing parameters 1106 can be configured, such as retry count, switch sensors or not, signal threshold, scheduling conflicts, and the like. Finally, a schedule can be determined through a schedule GUI 1108.

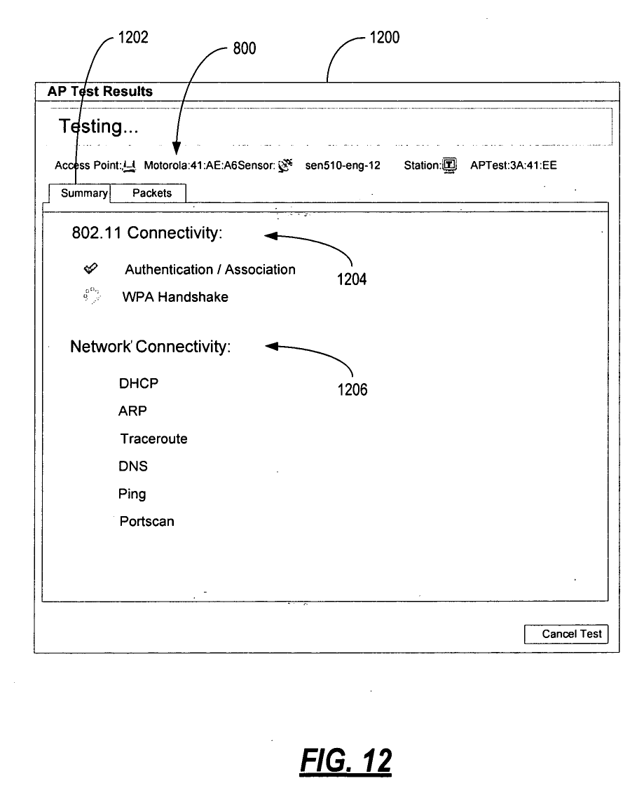

FIG. 12 illustrates an AP test results GUI screen 1200 and a summary tab 1202. The GUI screen 1200 shows the progress of a test for the AP 800. A summary list can include results from layer two testing, i.e. 802.11 connectivity 1204, and results from layer three testing, i.e. network connectivity 1206. Each test can include a graphical status, e.g. green check for pass, red X for fail, etc.

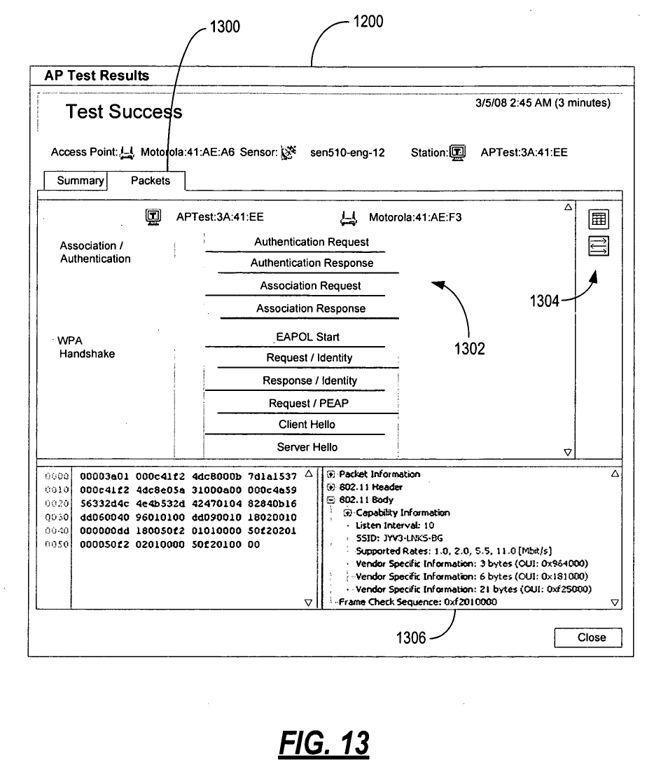

FIG. 13 illustrates the AP test results GUI screen 1200 and a packets tab 1300. The packets tab 1300 includes a ladder diagram 1302 of frames exchanged in the connectivity tests with pass/fail results. Alternatively, the ladder diagram 1302 can be in a table format, e.g. by selecting an icon 1304. Additionally, the user can select a particular frame, e.g. Association Response, and information 1306 is displayed associated with the selected frame.

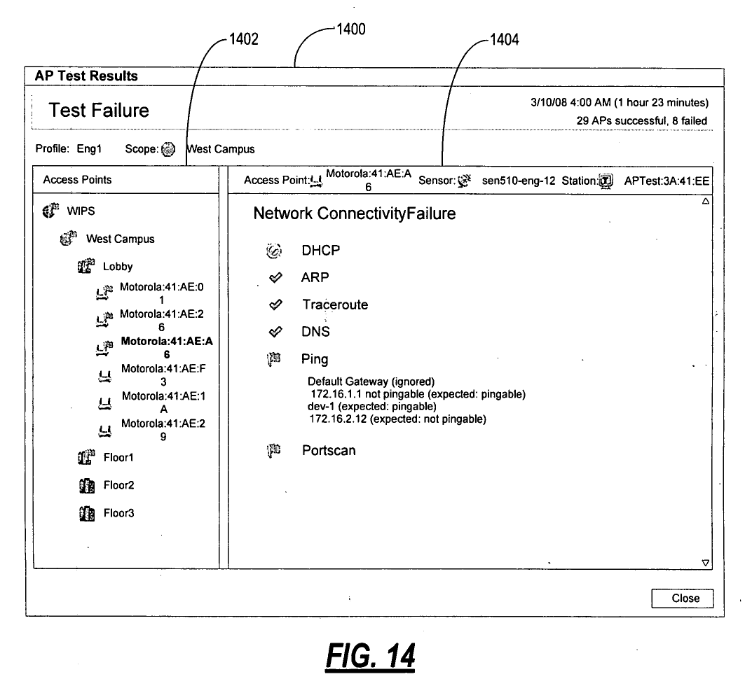

FIG. 14 illustrates an AP test results GUI screen 1400 for a failed test in a plurality of scheduled tests. The GUI screen 1400 includes an AP list 1402. The user can select a particular AP, and test results 1404 are displayed. Here, the AP failed the Ping and Portscan tests under layer three testing.

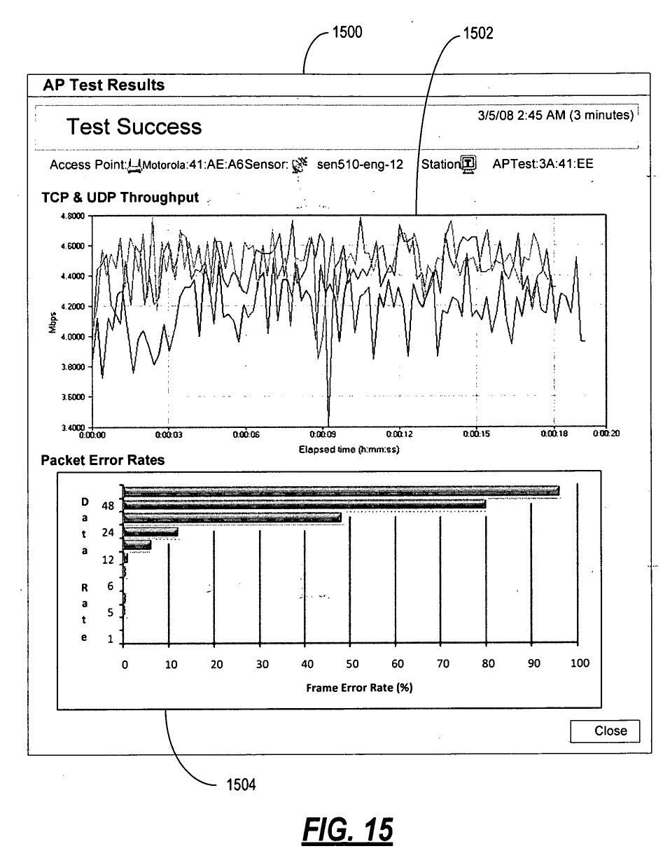

FIG. 15 illustrates a detailed performance test report 1500 for an AP. A first graph 1502 shows the measured throughput over time for TCP and UDP traffic, and a second graph 1504 shows the PER for each operational rate supported by the AP.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A method for remote testing of a wireless local area network access point, comprising:
selecting an access point to test;
selecting a sensor in range of the access point;
configuring the sensor as a wireless local area network client; and
testing the access point with the sensor.

2. The method of claim 1, wherein the sensor comprises a monitoring sensor configured to provide wireless network monitoring for wireless network intrusions in conjunction with a server that is in communication with the sensor.

3. The method of claim 2, wherein the configuring the sensor as a wireless local area network client comprises assigning the sensor a media access control address to operate as a wireless client device.

4. The method of claim 3, wherein the configuring the sensor as a wireless local area network client further comprises configuring the sensor to lock on and operate on a wireless channel that the access point is operating on.

5. The method of claim 1, wherein testing the access point comprises performing layer two connectivity tests and layer three connectivity tests.

6. The method of claim 5, wherein the layer two connectivity tests comprise any of performing an association between the sensor and the AP, performing a four-way handshake and installing temporal and group keys, and performing physical layer rate testing comprising measuring a packet error rate based on acknowledgments received at the sensor from the AP.

7. The method of claim 6, wherein the layer three connectivity tests comprise any of assigning an Internet Protocol address to the sensor operating as a wireless client, performing a ping to a known machine on a wired network connected to the wireless network, performing a traceroute test to the known machine, performing network performance testing comprising performing Transmission Control Protocol (TCP) and User Datagram Protocol (UDP) throughput tests, scanning for open/blocked ports and services, and performing a Domain Name System test.

8. The method of claim 7, wherein the layer two connectivity tests and the layer three connectivity tests are each selected based upon user requirements and network configuration.

9. A wireless monitoring system configured for remote testing of an access point, comprising:
one or more wireless sensors configured to monitor traffic on a wireless network;
one or more servers communicatively coupled to the one or more wireless sensors; and
a remote access point testing procedure executed on one of the one or more wireless sensors and one of the one or more servers, wherein the remote access point testing procedure is configured to convert the one of the one or more wireless sensors to a wireless client in order to remotely test the access point.

10. The wireless monitoring system of claim 9, wherein the one or more wireless sensors and the one or more servers comprise one of a wireless monitoring system, a wireless intrusion detection system, and a wireless intrusion prevention system.

11. The wireless monitoring system of claim 10, wherein the one or more wireless sensors are configured to operate in a promiscuous mode while monitoring and converted to client mode to remotely test the access point.

12. The wireless monitoring system of claim 9, wherein the to convert the one of the one or more wireless sensors to a wireless client comprises assigning the one of the one or more wireless sensors a media access control address to operate as a wireless client device.

13. The wireless monitoring system of claim 9, wherein to remotely test the access point the system performs layer two connectivity tests and layer three connectivity tests.

14. The wireless monitoring system of claim 13, wherein the layer two connectivity tests comprise any of performing an association between the sensor and the AP, performing a four-way handshake and installing temporal and group keys, and performing physical layer rate testing comprising measuring a packet error rate based on acknowledgments received at the sensor from the AP.

15. The wireless monitoring system of claim 13, wherein the layer three connectivity tests comprise any of assigning an Internet Protocol address to the sensor operating as a wireless client, performing a ping to a known machine on a wired network connected to the wireless network, performing a traceroute test to the known machine, performing network performance testing comprising performing Transmission Control Protocol (TCP) and User Datagram Protocol (UDP) throughput tests, scanning for open/blocked ports and services, and performing a Domain Name System test.

16. The wireless monitoring system of claim 9, further comprising a graphical user interface for configuring, executing the test of the access point, and providing a test report.

17. A wireless monitoring method, comprising:
providing the wireless monitoring system comprising a server communicatively coupled to one or more distributed wireless sensors;
monitoring the wireless network for intrusions with the wireless monitoring system;
configuring access point test parameters in the wireless monitoring system; and
responsive to access point test parameters, testing one or more access points in the wireless network with the wireless monitoring system.

18. The wireless monitoring method of claim 17, wherein the testing comprises converting a sensor of the one or more distributed wireless sensors into a wireless client configured to communicate on the wireless network and performing wireless connectivity tests between the sensor and the access point.

19. The wireless monitoring method of claim 18, wherein the layer two connectivity tests comprise performing an association between the sensor and the AP, performing a four-way handshake and installing temporal and group keys, and performing physical layer rate testing comprising measuring a packet error rate based on acknowledgments received at the sensor from the AP.

20. The wireless monitoring method of claim 18, wherein the layer three connectivity tests comprise assigning an Internet Protocol address to the sensor operating as a wireless client, performing a ping to a known machine on a wired network connected to the wireless network, performing a traceroute test to the known machine, performing network performance testing comprising performing Transmission Control Protocol (TCP) and User Datagram Protocol (UDP) throughput tests, scanning for open/blocked ports and services, and performing a Domain Name System test.
